(19) United States
(12) Patent Application Publication
(10) Pub. No.: US 2012/0130791 A1
(43) Pub. Date: May 24, 2012

(54) SYSTEM AND METHOD FOR MANAGING LOCATION-BASED INCENTIVES

(75) Inventors: Tom CARTER, San Francisco, CA (US); Parthiv Patel, Mountain View, CA (US)

(73) Assignee: Matchpin LLC, San Francisco, CA (US)

(21) Appl. No.: 12/951,860

(22) Filed: Nov. 22, 2010

(51) Int. Cl. G06Q 30/00

(52) U.S. Cl. 705/14.26; 705/14.1

(57) ABSTRACT

Location-based incentives may be provided to users via wireless client devices wirelessly. Redemption requests may be verified based on geolocation information related to the client devices that received the incentives at the times that redemptions are requested. The use of such geolocation information to verify redemption requests may provide a separate layer of verification to inhibit fraud by users and/or merchants, and/or provided other enhancements.

### FIELD OF THE INVENTION

The invention relates generally to location-based incentives provided to users via wireless client devices, and more particularly to using geolocation information obtained from the wireless client devices to verify redemption requests. Demand for the location-based incentives that are not presently available may be determined, and/or provided to potential offerors in order to demonstrate the value of the location-based incentives.

### BACKGROUND OF THE INVENTION

Location-based incentive systems are known. In conventional location-based incentive systems, incentives may be provided to the mobile devices of users based on location information (e.g., global positioning system information) received from the mobile devices. For example, a user holding her mobile device in front of a particular merchant location may receive incentives on the mobile device to purchase goods or services at the merchant location.

Various incentives, e.g., coupons, can be redeemed by a user with a merchant to receive the value of the incentive (e.g., a user receiving a discount on the purchase of a particular product). In some cases, the coupon (or other incentive) may be issued by the manufacturer of the product. In such cases, the merchant then seeks reimbursement from the manufacturer for the discount given to the user.

Fraud in consumer incentive programs is prevalent and well known. Two sources of fraud may include illicit copying/redemption by consumers (copying coupons) and/or false claims for reimbursement by merchants. Consumers may attempt to copy a coupon (or other incentive) to redeem a single incentive multiple times, sell copies of the coupons to others and/or otherwise violate the incentive rules. Merchants may claim to have provided incentive to users without actually providing such incentives. Merchants may make such claims to illicitly obtain “reimbursement.”

Fraud, of the types described above and otherwise, may be an issue with traditional, paper-based incentives. The distribution of incentives to mobile devices, for which users do not provide a tangible incentive offer (e.g., a printed coupon) to a merchant at redemption, may open the door to other types of fraud.

### SUMMARY

One aspect of the invention relates to the creation and redemption of incentives, such as coupons, discounts, giveaways and/or other incentives. The incentives may be created for distribution to users via wireless transmission to client devices associated with the users. The transmission of the incentives may be location-based (e.g., based on detected locations of the client devices). Redemption to a user and/or reimbursement to a merchant of an incentive may be contingent on a verification process. The verification process may verify that a transaction upon which the incentive is conditioned actually took place. This may include one or both of verifying the user was at the location of the transaction, and/or that a payment account associated with the user was accessed to pay for the transaction by the user. The verification of user location may be accomplished based on the detected location of the client device associated with the user. The verification that the payment account was accessed to pay for the transaction may be accomplished through communication with an entity providing the payment account.

Another aspect of the invention relates to determining user demand for incentives that are not currently offered, aggregating such demand, and/or reporting demand to potential offerors to demonstrate the value of offering an incentive. The determination and/or aggregation of the demand for such incentives may be based on the reception of incentive requests from users. The incentive requests may be received via wireless transmission from client devices associated with the users.

Yet another aspect of the invention relates to a system and method of verifying and/or validating redemption/reimbursement requests for location based (and other) incentives. Redemption requests from users and/or reimbursement requests from merchants may be verified based on: i) geolocation information related to the client devices that received the incentives at the times that criteria associated with the incentives are supposedly satisfied; and/or ii) verification that users actually participated in purchases or transactions required for redemption of incentives. The use of such geolocation information, and/or user purchase information to verify redemption requests may provide one or more separate layers of verification to inhibit fraud by users and/or merchants, and/or provided other enhancements. Verification using geolocation information and/or user purchase information may be used to process redemption requests generated at the time an award associated with an incentive is provided to a user, and/or to process reimbursement requests by merchants that have previously provided an award to a user.

In some implementations, the system may include one or more servers having one or more processors configured to execute computer program modules. The computer program modules may include one or more of an incentive creation module an incentive provision module, a redemption request module, a user location module, a redemption verification module, a redemption grant module, and/or other modules.

The incentive creation module may be configured to create incentives for purchasing goods and/or services at merchants. Incentives may be offered by offerors, such as merchants, providers of goods and/or services (e.g., a manufacturer or distributor of a product), and/or other offerors. Incentives may be defined by incentive criteria. Incentive criteria may include one or more of an incentive identification, an offeror identification, a user/client device identification, purchase criteria, an award, a temporal requirement, a redemption code, a location requirement, distribution mechanism (e.g., downloadable from website, through a dedicated application, and/or other distribution mechanisms) and/or other criteria. The incentive creation module may create incentives and/or determine incentive criteria automatically (e.g., based on predetermined rules and/or previously obtained information) and/or based on input received from offerors of incentives (e.g., through a website, through a dedicated application, and/or via other communications mechanisms).

The incentive provision module may be configured to provide incentives for purchasing goods or services to users. The determination of which incentives should be made available to which users may be based on behavioral and/or historical information about the users, geolocation information specifying the locations of the client devices, demographic information, and/or other information. For simplicity, many of the examples below will relate to wireless distribution of incentives to mobile devices. However, the invention is not so limited. The scope of this disclosure may include other distribution models, including electronic or paper-based distribution of incentives for which a tangible copy (e.g., a print-out) is presented at redemption and/or other types of incentives and distribution techniques.

The redemption request module may be configured to receive redemption requests and/or reimbursement requests for incentives. A redemption request may indicate a request by a user for the award associated with an incentive. A reimbursement request may indicate a request by a merchant for reimbursement for the award associated with an incentive that has allegedly been provided to a user. A redemption/reimbursement request may include a redemption request time. The redemption request time may be the time at which a user allegedly performed activities that should result in redemption/reimbursement of the incentive. This may be a time at which the purchase satisfying the purchase criteria was initiated, completed, and/or ongoing. The redemption/reimbursement requests may be received from the client devices associated with the users, from merchant computing platforms associated with merchants, and/or from other sources. A redemption request may be generated and/or processed before a merchant has provided the award of the incentive to the user, and/or a reimbursement request may be generated and/or processed after the merchant has already provided the award to the user. The redemption request may be a request for the award to be provided directly to the user. The reimbursement request may be a request for the award to be provided to the merchant that has already provided to the award to the user.

The user location module may be configured to obtain geolocation information from the client devices. Geolocation information obtained from a client device may specify the geolocation of the client device. The geolocation information may be transmitted wirelessly from the client devices. The user location module may be configured to obtain the geolocation information in real-time, near-real time, and/or after a delay. The geolocation information may be implemented by the incentive provision module in the distribution of the incentives. The geolocation information may include one or more of Internet protocol address, MAC address, RFID information, Wi-Fi connection location, Global Positioning System coordinates, radio frequency triangulation information, and/or other information.

The redemption verification module may be configured to determine whether redemption/reimbursement requests should be verified. Verification (or non-verification) may be based on comparison of information included with the redemption/reimbursement requests and/or geolocation information with incentive criteria. For example, the redemption verification module may be configured to compare the geolocation information of a client device associated with a user of a redemption/reimbursement request with the location requirement of the incentive being requested. Verification of the redemption/reimbursement request by the redemption verification module may be contingent on the geolocation information satisfying the location requirement.

The redemption verification module may be configured to confirm that a user has made a purchase at the redemption request time. Verification of a redemption/reimbursement request may be contingent upon the user having made the required purchase (or performance of other requirements) at the redemption request time. In some implementations, the redemption verification module may have access to a record of purchases made by the user using a payment account (e.g., a bank account, a credit card account, a pre-paid account, a pay-anyone account, and/or other accounts). The record of purchases may be used to confirm the user has made a purchase that corresponds to the purchase criteria included in the redemption/reimbursement request (e.g., at the redemption request time, for the purchase amount, and/or other criteria).

The redemption grant module may be configured to grant the redemption/reimbursement requests responsive to verification of the redemption/reimbursement requests. Granting a redemption/reimbursement request may include providing the award for the requested incentive to the user, and/or crediting the award to a merchant (if the merchant has already provided the award to the user).

Still another aspect of the invention may relate to a system and method for demonstrating user demand for incentives not currently available. This information may be implemented to demonstrate value in offering incentives to potential offerors. The demand for incentives may be determined on a per-offeror basis, a per-good or service basis, a per-merchant location basis, and/or on the basis of other incentive criteria. Reports of user demand may be generated for provision to potential offerors, which may then create incentives corresponding to the demanded incentives.

In some implementations, a system configured to demonstrate demand for incentives for purchasing goods or services. The system may include one or more servers having one or more processors configured to execute computer program modules. The computer program modules may include one or more of an incentive request module, an incentive demand module, a demand reporting module, and/or other modules. The system may be a location-based incentive system configured to provide incentives to users on the basis of geolocation information.

The incentive request module may be configured to receive incentive requests from client devices associated with users. The incentive requests may be transmitted wirelessly from the client devices. The incentive requests may be for incentives not currently offered to users through the system. The incentive requests may include incentive request criteria. The incentive request criteria for a given incentive request may include an offeror identification, a merchant location, and/or other criteria. In the location-based incentive system, the merchant location may be determined based on geolocation information obtained from the client devices from which the incentive requests were received.

The incentive demand module may be configured to determine user demand for incentives for having at least some incentive criteria in common. For example, the incentive demand module may be configured to determine demand for incentives for purchasing goods or services at individual merchant locations. The determination of user demand for incentives may be determined based on the incentive requests received by the incentive request module. For example, incentive requests for incentives at a given merchant location may be aggregated (e.g., counted) to determine user demand for incentives at the given merchant location.

The demand reporting module may be configured to generate reports conveying the user demand for incentives for purchasing goods or services at the individual merchant locations. The reports may be presented to potential offerors and/or the users that requested the incentives. The reports may be presented to potential offerors via a website or webpage, via electronic communication (e.g., email), and/or via other communication media.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to create, provide, verify, and/or grant redemption of incentives for purchasing goods and/or services to users, in accordance with one or more embodiments of the invention.

FIG. 2 illustrates a user interface that presents a plurality of incentives to a user, according to one or more embodiments of the invention.

FIG. 3 illustrates a user interface by which user selection and/or input of the incentive requests may be received, in accordance with one or more embodiments of the invention.

FIG. 4 illustrates a user interface that presents a report of user demand for incentives, according to one or more embodiments of the invention.

FIG. 5 illustrates a method of redeeming incentives, in accordance with one or more embodiments of the invention.

FIG. 6 illustrates a method of demonstrating user demand for incentives, according to one or more embodiments of the invention.

### DETAILED DESCRIPTION

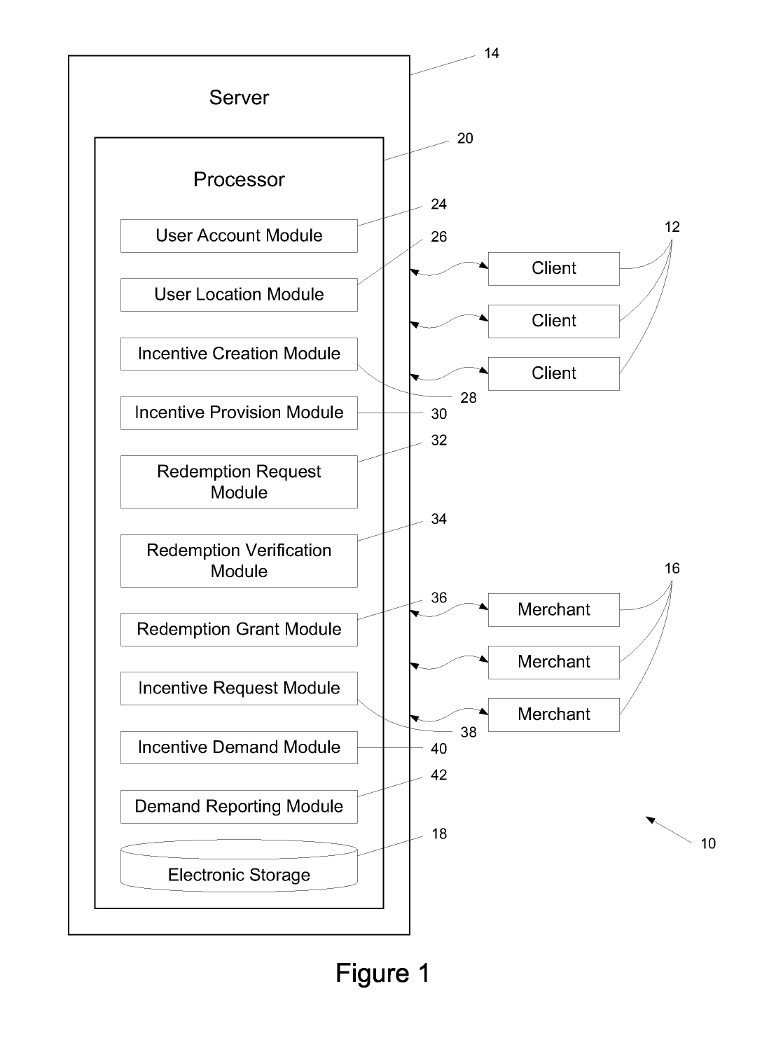

FIG. 1 illustrates a system 10 configured to create, provide, verify, and/or grant redemption of incentives for purchasing goods and/or services to users. The incentives may be provided to the users wirelessly via client devices 12. The system 10 may be configured to provide the incentives based on location. The system 10 may be configured to inhibit fraud in the redemption of incentives. The system 10 may be configured to receive incentive requests for incentives from previously non-participating merchants. The system 10 may be configured to report to the previously non-participating merchants, demand for incentives in order to motivate the previously non-participating merchants to begin offering incentives.

The system 10 may include one or more servers 14. The servers 14 may be configured to communicate with client devices 12 associated with the users. Such communications may include wireless communications. The client devices 12 may include one or more of a laptop computer, a Smartphone, a touch-based tablet computer, a handheld computer, a personal digital assistant, and/or other client devices. The client devices 12 may provide users with a user interface by which the users communicate with system 10. The user interface may include a screen, a touchscreen, a keypad, buttons, speakers, a keyboard, a switch, a knob, a projector, other electronic displays, other input devices, and/or other interface devices associated with or connected to client devices 12. The user interface may include one or more graphical user interfaces presented to users via electronic displays of client devices 12.

A given client device 12 may include one or more processors configured to execute a client application that provides client device 12 with access to system 10. The client application may include an application that is specialized for interfacing with system 10 (e.g., a Smartphone “app”, and/or other specialized applications), or an application that is configured to interface with a plurality of different servers and/or systems (e.g., a web browser and/or other multipurpose client applications). Views of the graphical user interface(s) provided by system 10 may be rendered on the client device 12, or views of the graphical user interface(s) may be streamed to the client device 12.

The servers 14 may be configured to communicate with merchant computing platforms 16 associated with individual merchants. The merchant computing platforms 16 may include one or more of a point-of-sale device associated with a merchant, a server associated with a merchant, and/or other computing platforms associated with merchants. The servers 14 may be configured to communicate with merchant computing platforms 16 via wired and/or wireless communication media. Communications between servers 14 and merchant computing platforms 16 may be accomplished via network and/or dedicated communication lines.

The servers 14 may be configured to host some or all of the functionality of system 10. The servers 14 may include one or more dedicated pieces of hardware, and/or servers 14 may include hardware concurrently hosting other functionality and/or services concurrently. In some implementations, servers 14 may include one or more of electronic storage 18, one or more processors 20, and/or other components.

The user interface 18 may include electronic storage media that electronically stores information. The electronic storage media of electronic storage 18 may include one or both of system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 18 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 18 may store software algorithms, information determined by processor 20, information received via client devices 12, and/or other information that enables system 10 to function properly. Electronic storage 18 may be a separate component within system 10, or electronic storage 18 may be provided integrally with one or more other components of system 10 (e.g., processor 20).

Processor 20 is configured to provide information processing capabilities in servers 14. As such, processor 20 may include one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some implementations, processor 20 may include a plurality of processing units. These processing units may be physically located within the same device, or processor 20 may represent processing functionality of a plurality of devices operating in coordination.

As is shown in FIG.1, processor 20 may be configured to execute one or more computer program modules. The one or more computer program modules may include one or more of a user account module 24, a user location module 26, an incentive creation module 28, an incentive provision module 30, a redemption request module 32, a redemption verification module 34, a redemption grant module 36, an incentive request module 38, an incentive demand module 40, a demand reporting module 42, and/or other modules. Processor 20 may be configured to execute modules 24, 26, 28, 30, 32, 34, 36, 38, 40, and/or 42 by software; hardware; firmware; some combination of software, hardware, and/or firmware; and/or other mechanisms for configuring processing capabilities on processor 20.

It should be appreciated that although modules 24, 26, 28, 30, 32, 34, 36, 38, 40, and 42 are illustrated in FIG. 1 as being co-located within a single processor, in implementations in which processor 20 includes processors, one or more of modules 24, 26, 28, 30, 32, 34, 36, 38, 40, and/or 42 may be located remotely from the other modules. The description of the functionality provided by the different modules 24, 26, 28, 30, 32, 34, 36, 38, 40, and/or 42 described below is for illustrative purposes, and is not intended to be limiting, as any of modules 24, 26, 28, 30, 32, 34, 36, 38, 40, and/or 42 may provide more or less functionality than is described. For example, one or more of modules 24, 26, 28, 30, 32, 34, 36, 38, 40, and/or 42 may be eliminated, and some or all of its functionality may be provided by other ones of modules 24, 26, 28, 30, 32, 34, 36, 38, 40, and/or 42. As another example, processor 24 may be configured to execute one or more additional modules that may perform some or all of the functionality attributed below to one of modules 24, 26, 28, 30, 32, 34, 36, 38, 40, and/or 42.

The user account module 24 may be configured to manage user accounts associated with users of system 10. The user accounts may include, for example, identification information (e.g., a username or handle, a number, an identifier, a name, and/or other identifying information), security information (e.g., a password, a login, an answer to a security question, and/or other security information), subscription information, friend information (e.g., information related to friends of a user), incentive redemption/request history information, demographic information associated with users, information stated by users, purchase information of users, client device identification information with a user, contact information (e.g., phone number, email address, and/or other contact information), and/or other information related to users.

The user location module 26 may be configured to obtain and/or manage geolocation information of client devices 12. The geolocation information may specify the physical locations of client devices 12. The geolocation information may include one or more of Internet protocol address, MAC address, RFID information, Wi-Fi connection location, Global Positioning System coordinates, radio frequency triangulation information, information entered to client device 12 by a user (e.g., specifying the location of client 12), and/or other information. The user location module 26 may be configured to obtain geolocation information of one or more of client device 12 in a substantially ongoing manner (e.g., at a sampling rate), at discrete intervals, responsive to user selection or input, and/or according to other schemes. The user location module 26 may be configured to obtain geolocation information that has been transmitted wirelessly from client devices 12. The user location module 26 may be configured to obtain geolocation information that has been stored at client devices 12 for transmission to user location module 26 at a later time (e.g., when docked to a computer). The user location module 26 may be configured to manage storage of geolocation of client devices 12. This may facilitate determination of the location of one of client device 12 at some previous time.

The incentive creation module 28 may be configured to create incentives for purchasing goods and/or services at the merchants associated with merchant computing platforms 16. Incentives may be defined by incentive criteria. Incentive criteria may include one or more of an incentive identification, an offeror identification, a user/client device identification, purchase criteria, an award, a temporal requirement, a redemption code, a location requirement, and/or other criteria.

The incentive identification may identify the incentive. The incentive identification may include an alphanumeric identification, an optical code (e.g., a bar code, a two-dimensional optical code, and/or other codes), and/or other identifiers. The incentive identification may identify an incentive that is sent out to a plurality of client devices 12, or the incentive identification may uniquely identify an incentive such that from the incentive identification that client device 12 and/or user that received the incentive can be determined.

An offeror identification may identify the offeror offering the incentive. The offeror may include a merchant. The offeror may include an entity that provides goods or services for which an incentive is offered (e.g., the manufacturer or distributor of a product). The offeror identification may include an alphanumeric identification, an optical code (e.g., a bar code, a two-dimensional optical code, and/or other codes), and/or other identifiers. The offeror identification may identify a merchant with multiple merchant locations generically, or the offeror identification may identify a specific merchant location of merchant having multiple merchant locations.

The user/client device may identify the client device 12 and/or the associated user that received the incentive. The user/client device identification may include an alphanumeric identification, an optical code (e.g., a bar code, a two-dimensional optical code, and/or other codes), and/or other identifiers.

In some implementations, the incentive criteria may include a composite identifier. The composite identifier may indicate the identity of two or more of the incentive itself, the merchant offering the incentive, and/or the user or client device 12 receiving the incentive. The composite identifier may include an alphanumeric identification, an optical code (e.g., a bar code, a two-dimensional optical code, and/or other codes), and/or other identifiers.

The purchase criteria may specify parameters of a purchase the must be satisfied in order to receive the award. The purchase criteria may specify one or more specific goods or services to be purchased, a threshold amount to be spent, and/or other purchase parameters.

The award may be the benefit bestowed on a user for using the incentive in a purchase (e.g., a purchase meeting the purchase criteria). The award may include, for example, a discount percentage, a discount amount, a definition of free product, a subscription, and/or other benefits.

The temporal requirement may set one or more temporal restrictions on a purchase for which the incentive can be used or claimed. Such temporal restrictions may include a maximum time from distribution, a daily time period, a day of the week, a day of the month, a specific day, a specific time period, and/or restrictions.

The redemption code may include information to be manifested by the user and/or the client device 12 in order to redeem the incentive. The redemption code may include, for example, an alphanumeric code to be entered manually by the user during the purchase, an optical code (e.g., a bar code, a two-dimensional optical code, and/or other codes) to be presented to the merchant at the time of purchase, and/or other codes that could be provided from the user to the merchant at the time of purchase (e.g., at the transaction).

The location requirement may specify one or more geographic locations and/or regions at which the client device 12 and/or the user must be present to redeem the incentive. The one or more geographic locations may correspond to merchant locations for which purchases are incentivized by the incentive. For example, if the incentive incentivizes purchase from a particular merchant location, the location requirement may specify a region that corresponds to the merchant location. Unless the client device 12 and/or the user is present at the region corresponding to the merchant location at the time of purchase, the award of the incentive may not be provided to the user. This may inhibit fraud in incentive redemptions, as an incentive may not be redeemed without an independent determination that the user and/or the client device 12 has satisfied the location requirement.

The incentive creation module 28 may be configured such that incentive criteria for incentives may be determined automatically, by default, and/or via user selection and/or input. For example, incentive creation module 28 may be configured to host a website (or webpage) accessible to merchants and/or to entities that provide goods or services sold at the merchants (e.g., the manufacturer or distributor of a product). The merchants or the entities that provide goods or services may enter or select incentive parameters for incentives via the website. The incentive creation module 28 may be configured to present a user interface to an administrator associated with the entity operating system 10. The user interlace may be configured to receive entry or selection of incentive parameters by the administrator (e.g., based on direction or instructions from merchants). The user interface may be provided via a website (or webpage) hosted by incentive creation module 28.

The incentive creation module 28 may be configured to determine incentive criteria automatically. For example, incentive creation module 28 may be configured to automatically determine incentive criteria to create incentives for specific users that are most likely to be redeemed by the users. The automatic determination of incentive criteria for an incentive to be provided to a given user (and/or the client device 12 associated with the given user) may be based upon information included in the user account that is associated with the given user.

The incentive creation module 28 may be configured to determine incentive criteria at or near the time of distribution, and/or prior to the time of distribution. For example, an award for incentives may be determined prior to the time of distribution while the user identification of the incentive may be determined at or near the time of distribution.

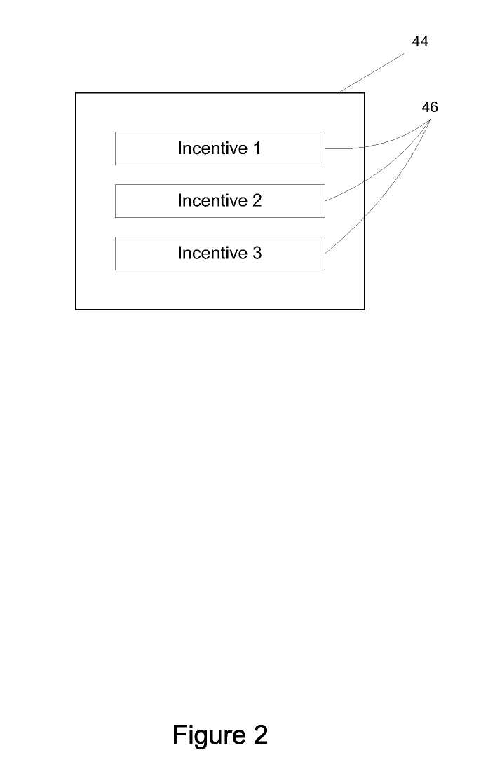

The incentive provision module 30 may be configured to provide incentives to users via the client devices 12 associated with the users. This may include transmitting incentives to the users such that the incentives are received wirelessly by client devices 12. The incentive provision module 30 may be configured such that the incentives are provided to the users via a user interface presented to users on client devices 12. By way of non-limiting example, FIG. 2 illustrates a user interface 44 that presents a plurality of incentives 46. The user interface 44 may be presented to a user via a client device associated with the user. The presentation of incentives 46 on user interface 44 may include some incentive criteria defining incentives 46. For example, an incentive identification, a merchant name, a merchant location, an identification of a product, temporal restrictions, and/or other incentive criteria may be presented. In some implementations, incentives 46 may be selectable. Responsive to selection of one of incentives 46, further incentive criteria associated with the selected incentive 46 may be presented on user interface 44.

Returning to FIG. 1, the incentive provision module 30 may be configured to provide incentives to users based on factors such as past incentive redemption history, past incentive requests, and/or other factors. The incentive provision module 30 may be configured to provide incentives to users based on the location of the users and/or their associated client devices 12. For example, incentive provision module 30 may obtain geolocation information related to client devices 12 from user location module 26, and may implement the geolocation information to distribute incentives to the users.

The geolocation information may include real-time or near real-time geolocation information. For example, responsive to a given client device 12 being located near a give merchant offering incentives through system 10, incentive provision module 30 may distribute one of the offered incentives to the user. The geolocation information may include historical geolocation information. For example, responsive to a user habitually travelling along a route close to a merchant for which incentives are being offered through system 10 (this may include a merchant selling goods or services for which incentives are being offered by the entity that provides the goods or services), incentive provision module 30 may distribute one of the offered incentives to the user.

The redemption request module 32 may be configured to receive redemption requests and/or reimbursement requests (collectively “redemption/reimbursement requests”). A redemption/reimbursement request may indicate a request by a user for an award associated with a previously distributed incentive. The redemption requests may be received from client devices 12 and/or other sources. The reimbursement requests may be received from merchant computing platforms 16 and/or from other sources. A redemption request may be generated and/or processed before a merchant has provided the award of the incentive to the user. A reimbursement request may be generated and/or processed after the merchant has already provided the award to the user. The redemption request may be a request for the award to be provided directly to the user. The reimbursement request may be a request for the award to be provided to the merchant that has already provided to the award to the user.

A redemption/reimbursement request may include an indication that the user has satisfied at least some of the incentive criteria defining the incentive. For example, the redemption/reimbursement request may indicate a purchase of the user satisfies the purchase criteria associated with the incentive. This may include providing the purchase criteria of the purchase in the redemption/reimbursement request.

The redemption/reimbursement request may include a redemption code. The redemption code may have been entered manually by the user and/or the merchant at the time of the purchase, obtained automatically (e.g., electronic communication between client device 12 and merchant computing platform 16, scanned by merchant computing platform 16, and/or obtained automatically in other ways).

The redemption/reimbursement request may include incentive criteria defining the incentive for which redemption or reimbursement is being requested. For example, the redemption/reimbursement request may include an incentive identification, a user/client device identification, an award, a location requirement, and/or other incentive criteria.

The redemption/reimbursement request may include a redemption request time. The redemption request time may be the time at which a user allegedly performed activities that should result in redemption or reimbursement of the incentive. This may be a time at which the purchase satisfying the purchase criteria was initiated, completed, and/or ongoing.

The redemption verification module 34 may be configured to verify (or not verify) redemption/reimbursement requests received by redemption request module 32. The redemption verification module 34 may determine whether or not to verify redemption/reimbursement requests based on a comparison between incentive criteria defining incentives corresponding to the redemption/reimbursement requests, and the information included in the redemption/reimbursement requests. In order to conduct such a comparison, redemption verification module 34 may access incentive criteria defining an incentive for which redemption/reimbursement is requested based on an incentive identification included in the redemption/reimbursement request. The redemption verification module 34 may be configured such that the determination of whether or not to verify redemption/reimbursement requests may be performed in real-time or near real-time at the time of a purchase, and/or after some delay.

The comparison of incentive criteria with information included in a redemption/reimbursement request may include a comparison of purchase criteria. The redemption verification module 34 may compare purchase criteria included in the incentive criteria of an incentive with purchase criteria included in the redemption/reimbursement request. This comparison may include determining if the purchase criteria included in the redemption/reimbursement request satisfy the purchase criteria included in the incentive criteria. Responsive to the purchase criteria in the redemption/reimbursement request not satisfying the purchase criteria of the incentive criteria, redemption verification module 34 may determine the redemption/reimbursement request should not be verified. Conversely, responsive to the purchase criteria in the redemption/reimbursement request satisfying the purchase criteria of the incentive criteria, redemption verification module 34 may determine the redemption/reimbursement request should be verified.

The redemption verification module 34 may be configured to compare the redemption request time of a redemption/reimbursement request with the temporal restrictions of an incentive. This comparison may include determining if the time of the purchase satisfies the temporal restrictions of the incentive. Verification of the redemption/reimbursement request by redemption verification module 34 may be conditional on the redemption request time satisfying the temporal restrictions.

The redemption verification module 34 may be configured to confirm that a user has made a purchase at the redemption request time. Verification of a redemption/reimbursement request may be contingent upon the user having made the required purchase (or performance of other requirements) at the redemption request time. In some implementations, redemption verification module 34 may have access to a record of transactions conducted by the user. For example, redemption verification module 34 may have access to a record of purchases made by the user using a payment account (e.g., a bank account, a credit card account, a pre-paid account, a pay-anyone account, and/or other accounts). Such access may include access to an account statement or other information via electronic communication with the entity providing the account (e.g., the credit card company, the bank, and/or other entities).

In some implementations, users may register a payment account, or other form of payment, with system 10 to provide such access to redemption verification module 34. Registration of the payment account may include providing security information to system 10 that permits system 10 to obtain access to information related to the payment account via a website of the entity providing the registered payment account. Registration of the payment account may include providing authorization for the entity providing the registered payment account to give access to system 10 to information associated with the registered payment account.

The redemption verification module 34 may use geolocation information obtained by user location module 26 to determine whether or not to verify a redemption/reimbursement request. For a redemption/reimbursement request indicating request of an incentive award by a user, redemption verification module 34 may obtain the geolocation information for the client device 12 associated with the user at or near the redemption request time. The redemption verification module 34 may be configured to compare the obtained geolocation information with the location requirement of the incentive to determine whether the location requirement of the incentive has been satisfied. Verification of the redemption/reimbursement request by redemption verification module 34 may be conditional on the location requirement of the incentive being satisfied. This verification of location of client device 12, independent from merchant computing platforms 16, may inhibit fraud by consumers and/or by merchants. For example, a merchant may not be credited with redeeming an incentive unless redemption verification module 34 determines that the user and/or client device 12 that received the incentive was actually present at the merchant's location.

The redemption grant module 36 may be configured to grant redemption/reimbursement request that have been verified by redemption verification module 34. Granting a redemption/reimbursement request may include providing the award of the redemption/reimbursement request to a user, and/or crediting the award of the redemption/reimbursement request to a merchant (e.g., to reimburse the merchant for providing the award to the user). The award of the redemption/reimbursement request may be provided to the user at a point-of-sale (e.g., additional product, cash rebate, promotional product, and/or other awards), credited to a user account (e.g., a bank account, a credit card account, a pay-anyone account, and/or other accounts), mailed to the user, emailed to the user, and/or otherwise provided to the user. The award may be granted to the user at or near the time of the purchase, or after some delay.

The incentive request module 38 may be configured to receive incentive requests from client devices 12. The incentive requests (not to be confused with redemption requests) may be for incentives to purchase goods or services for which incentives are not currently being provided through system 10. Such incentive requests may include requests for incentives from a merchant (and/or merchant location), incentives for purchasing specific goods and/or services (e.g., without regard for merchant or along with a specified merchant), and/or other incentives.

The incentive request module 38 may be configured such that the incentive requests include incentive request criteria. The incentive request criteria may include one or more of a merchant identification, a merchant location, a product (e.g., good or service) identification, a requested award, and/or other criteria. The incentive request criteria may define certain aspects of the incentive being requested by the user in a given incentive request.

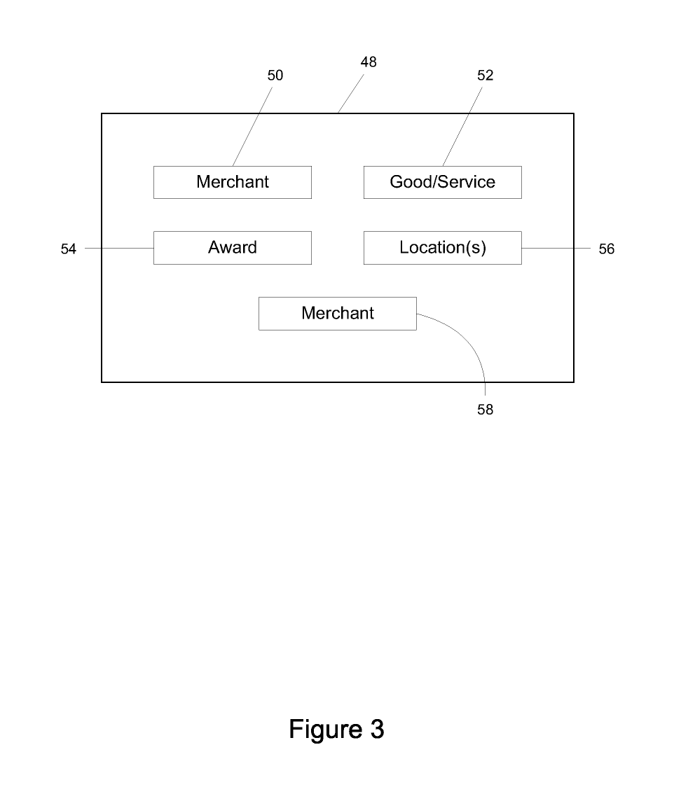

The incentive request module 38 may be configured to provide a user interface by which user selection and/or input of the incentive requests may be received. The user interface may be presented to the users via client devices 12. By way of illustration, FIG. 3 depicts a user interface 48. The user interface 48 may be provided by an incentive request module similar to or the same as incentive request module 38 (shown in FIG. 1 and described herein). The user interface 48 may be presented to a user on a client device similar to or the same as client device 12 (shown in FIG. 1 and described herein).

The user interface 48 may include one or more of an offeror field 50, a good/service field 52, an award field 54, a location field 56, a submission field 58, and/or other fields configured to receive entry or selection by the user of incentive request criteria. The illustration of fields 50, 52, 54, 56, and 58 on a single view of user interface 48 is not intended to be limiting. One or more of fields 50, 52, 54, 56, and/or 58 could be presented on different views.

The offeror field 50 may be configured to receive entry and/or selection by the user of an offeror for the incentive request (e.g., a merchant and/or a provider of goods or services). This may include receiving manual entry by the user, and/or selection by the user of an offeror from an automatically populated list. The list may be automatically populated based on the location of the client device (e.g., geolocation information obtained from the client device), offerors not currently offering incentives, and/or other criteria or parameters.

The good/service field 52 may be configured to receive entry and/or selection by the user of a good or service (e.g., a product) for the incentive request. The entry or selection of the good or service may be more specific (e.g., a specific product from a specific source or brand), or more general (e.g., a category of goods or services). Reception of entry and/or selection by the user may include receiving manual entry by the user, and/or selection by the user of a good or service from an automatically populated list. The list may be automatically populated based on the location of the client device, goods or services for which incentives are not currently being offered, and/or other criteria or parameters.

The award field 54 may be configured to receive entry and/or selection by the user of an award for the incentive request. Reception of entry and/or selection by the user of an award may include receiving manual entry by the user, and/or selection by the user of an award from an automatically populated list. The list may be automatically populated based on default options, awards not currently being offered, and/or other criteria or parameters.

The location field 56 may be configured to receive entry and/or selection by the user of a location for the incentive request. The location may be a merchant location. Selection of the entry by the user may include confirmation of an automatically determined location of the client device (e.g., geolocation information of the client device).

The submission field 58 may be configured to receive input by the user leading to reception and/or processing of the incentive request. For example, submission field 58 may include a selectable button that may be selected by the user to initiate transmission of the information in fields 50, 52, 54, and/or 56 to the incentive request module, and/or to initiate processing of the incentive request.

Returning to FIG. 1, incentive demand module 40 may be configured to determine user demand for incentives. This may include determining cumulative demand amongst the users of system 10 for incentives having at least some common incentive criteria. For example, incentive demand module 40 may determine cumulative demand for incentives with one or more of the same offeror, the same merchant location, the same goods or services, and/or other common incentive criteria. Determining cumulative demand may include determining a count of incentive requests having the common incentive request criteria, and/or aggregating incentive requests with common incentive request criteria in other ways (e.g., weighting the count based on user information).

The demand reporting module 42 may be configured to report user demand for incentives not currently being offered through system 10. This may include generating reports conveying the user demand for incentives. These reports may be presented to potential offerors (e.g., merchants, merchant locations, providers of goods or services, and/or other potential offerors). The reports may be presented to potential offerors via one or more websites (and/or webpages) having user interfaces therein that present the reports. The reports may be provided to the users that requested the incentives. These reports may spread virally, and may influence offeror behavior (e.g., to offer the demanded incentives).

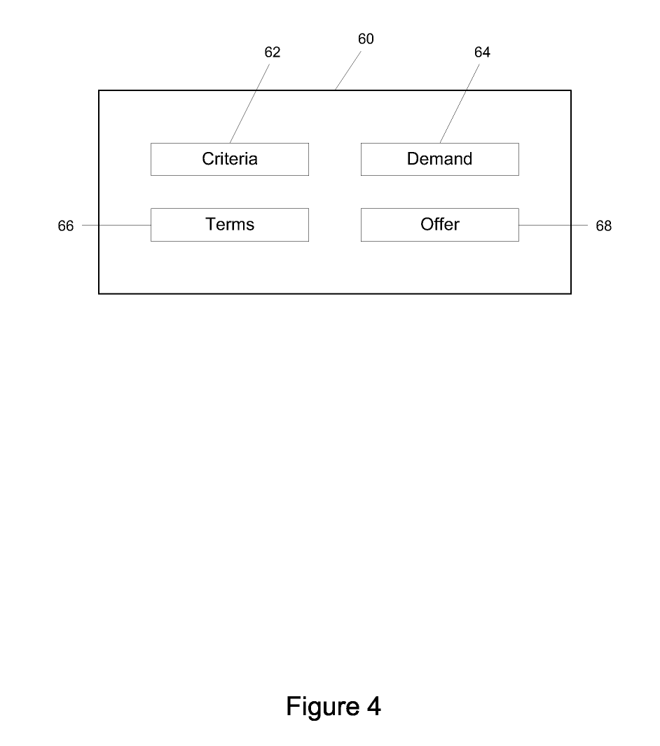

By way of illustration, FIG. 4 depicts a view 60 of a user interface that may be provided to potential offerors by a demand reporting module similar to or the same as demand reporting module 42 (shown in FIG. 1 and described herein). The view 60 may include one or more of a criteria field 62, a demand field 64, a terms field 66, an offer field 68, and/or other fields.

The criteria field 62 may convey incentive criteria defining one or more incentives for which demand is being reported by view 60. The incentive criteria may correspond to the common incentive request criteria from the incentive requests used to determine the demand for the one or more incentives. The incentive criteria conveyed by criteria field 62 may include one or more of an offeror, a merchant location, goods or services, an award, and/or other incentive criteria.

The demand field 64 may convey demand for the one or more incentives. The information conveying demand that is presented in demand field 64 may be determined by an incentive demand module similar to or the same as incentive demand module 40 (shown in FIG. 1 and described herein).

The terms field 66 may convey terms for offering an incentive. Such terms may include, for example, an amount charged by the operator of system 10 for incentive offers and/or redemptions, and/or other terms.

The offer field 68 may be configured to receive a request from the offeror to offer an incentive. The incentive may correspond to the one or more requested incentives. For example, responsive to reception of a request from the offeror to offer the incentive, an incentive creation module (e.g., similar to or the same as incentive creation module 28 shown in FIG. 1 and described herein) may provide a user interface to the offeror by which the offeror can create the incentive. In order to receive the request from the offeror, offer field 68 may include a selectable region on the user interface, and/or other fields configured to receive a user request.

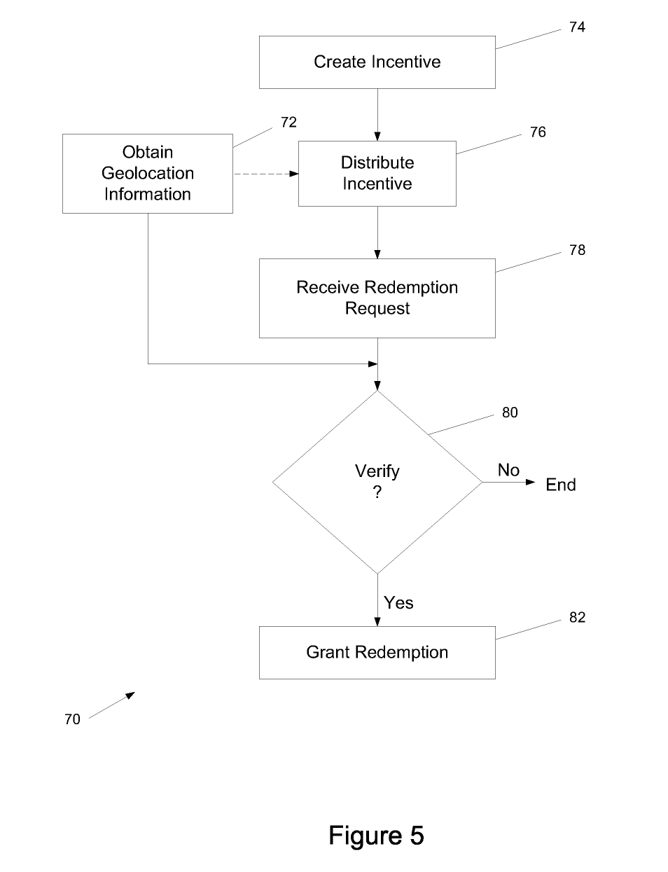

FIG. 5 illustrates a method 70 of redeeming incentives. The method 70 may inhibit fraud in the redemption of incentives delivered to users via client devices. The operations of method 70 presented below are intended to be illustrative. In some embodiments, method 70 may be accomplished with one or more additional operations not described, and/or without one or more of the operations discussed. Additionally, the order in which the operations of method 70 are illustrated in FIG. 5 and described below is not intended to be limiting.

In some embodiments, method 70 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 70 in response to instructions stored electronically on an electronic storage medium. The one or more processing devices may include one or more devices configured through hardware, firmware, and/or software to be specifically designed for execution of one or more of the operations of method 70.

At an operation 72, geolocation information may be obtained from a client device associated with a user. The geolocation information may be wirelessly transmitted from the client device. The geolocation information may specify the geolocation of the client device. In some implementations, operation 72 may be performed by a user location module similar to or the same as user location module 26 (shown in FIG. 1 and described above).

At an operation 74, an incentive for purchasing goods or services may be created. The incentive may be defined by incentive criteria. Creation of the incentive may include determining the incentive criteria defining the incentive. The incentive criteria may include incentive criteria that is determined automatically and/or incentive criteria that is determined based on user selection and/or entry. In some implementations, operation 74 may be performed by an incentive creation module similar to or the same as incentive creation module 28 (as shown in FIG. 1 and described above).

At an operation 76, the incentive may be distributed to the client device. Distribution of the incentive may include wirelessly transmitting the incentive to the client device for presentation to the user. Distribution of the incentive may be based on the incentive criteria, the geolocation information obtained from the client device, and/or other parameters. In some implementations, operation 76 may be performed by an incentive provision module similar to or the same as incentive provision module 30 (as shown in FIG. 1 and described above).

At an operation 78, a redemption/reimbursement request may be received. The redemption/reimbursement request may be received from the client device and/or from a merchant computing platform associated with a merchant from whom the goods or services are being purchased. The redemption/reimbursement request may include one or more of incentive criteria associated with the incentive, purchase parameters of the purchase of goods or services, a code, a redemption request time, and/or other information. In some implementations, operation 78 may be performed by a redemption request module similar to or the same as redemption request module 32 (as shown in FIG. 1 and described above).

At an operation 80, a determination may be made as to whether the redemption/reimbursement request should be verified. The determination may be made based on comparison of the information included in the redemption/reimbursement request with the incentive criteria defining the incentive. For example, the determination may be made based on a comparison of the geolocation information of the client device at or near the redemption request time with a location requirement included in the incentive criteria. In some implementations, operation 80 may be performed by a redemption verification module similar to or the same as redemption verification module 34 (as shown in FIG. 1 and described above).

Responsive to verification of the redemption/reimbursement request at operation 80, the redemption request may be granted at operation 82. Granting of the redemption/reimbursement request may include providing an award included in the incentive criteria to the user and/or reimbursing the award to the merchant (which may have already provided the award to the user). In some implementations, operation 82 may be performed by a redemption grant module similar to or the same as redemption grant module 36 (as shown in FIG. 1 and described above).

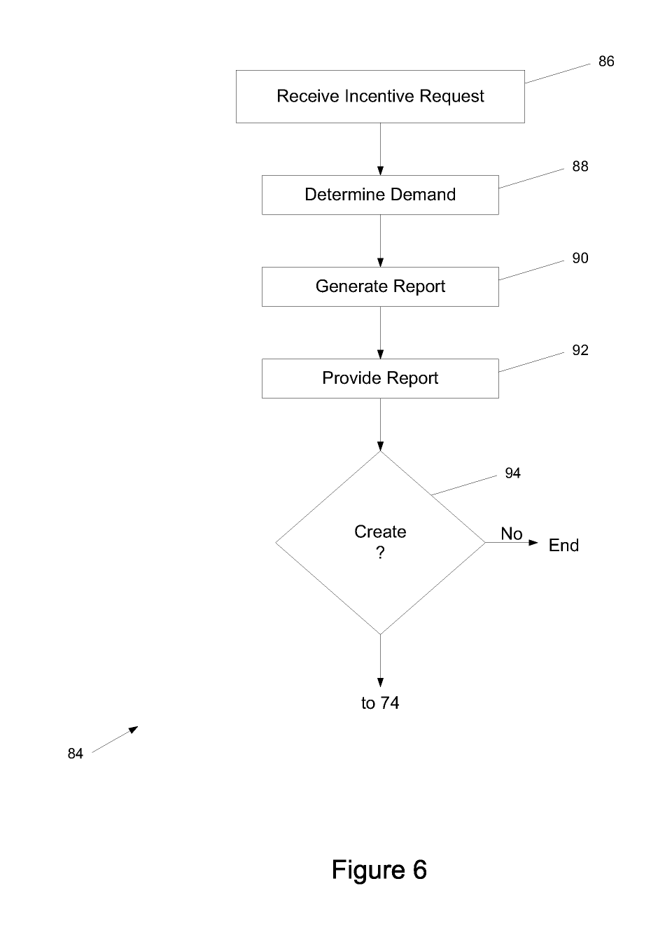

FIG. 6 illustrates a method 84 of demonstrating user demand for incentives. The operations of method 84 presented below are intended to be illustrative. In some embodiments, method 84 may be accomplished with one or more additional operations not described, and/or without one or more of the operations discussed. Additionally, the order in which the operations of method 84 are illustrated in FIG. 6 and described below is not intended to be limiting.

In some embodiments, method 84 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 84 in response to instructions stored electronically on an electronic storage medium. The one or more processing devices may include one or more devices configured through hardware, firmware, and/or software to be specifically designed for execution of one or more of the operations of method 84.

At an operation 86, incentive requests may be received from users. The incentive requests may be requests for incentives not previously offered. For example, the incentive request may be for incentives having incentive criteria different from incentives being offered. The incentive requests may be for requests having different offerors, goods or services, merchant locations, and/or incentive criteria different from offered incentives. The incentive requests may be transmitted wirelessly from client devices associated with the users. The incentive requests may include incentive request criteria corresponding to the incentive criteria the users would like. In some implementations, operation 86 may be performed by an incentive request module similar to or the same as incentive request module 38 (as shown in FIG. 1 and described above).

At an operation 88, user demand for an incentive not currently available may be determined. The user demand for the incentive may be determined from incentive requests for the incentive. In some implementations, operation 88 may be performed by an incentive demand module similar to or the same as incentive demand module 40.

At an operation 90, a report conveying the user demand for the incentive may be generated. The report may be designed to convey the user demand to a potential offeror of the incentive (e.g., an offeror indicated in the incentive requests). In some implementations, operation 90 may be performed by a demand reporting module similar to or the same as demand reporting module 42 (as shown in FIG. 1 and described above).

At an operation 92, the report may be provided to the potential offeror. The report may be provided to the potential offeror via a website or webpage, an electronic communication (e.g., email), and/or other communication media. In some implementations, operation 92 may be performed by a demand reporting module similar to or the same as demand reporting module 42 (as shown in FIG. 1 and described above).

At an operation 94, a determination may be made as to whether the incentive should be created. The determination may be based on a willingness of the potential offeror to offer the incentive. For example, the determination may be based on the receipt (or non-receipt) of a request from the potential offeror to offer the incentive. The provision of the report to the potential offeror at operation 92 may inform the decision of the offeror as to whether or not to request creation of the incentive. Responsive to a determination that the incentive should be created, method 84 may proceed, for example, to operation 74 of method 70 (shown in FIG. 5 and described above).

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system configured to inhibit fraud in redemption of incentives delivered to users via client devices, the system comprising:
one or more processors configured to execute computer program modules, the computer program modules comprising:
a redemption request module configured to receive a redemption request for an incentive, wherein the incentive is defined by incentive criteria including an identification, an award, and a location requirement, wherein the redemption request indicates a request for the award associated with the incentive by the user, and wherein the redemption request includes a redemption request time at which the user requested redemption of the incentive;
a user location module configured to obtain geolocation information specifying the geolocation of a client device associated with the user at the redemption request time;
a redemption verification module configured to compare the geolocation information of the client device at the redemption request time with the location requirement, and to verify or not verify the redemption request based on this comparison; and
a redemption grant module configured to grant the redemption request responsive to verification of the redemption request.

2. The system of claim 1, wherein the computer program modules further comprise an incentive provision module configured to transmit the incentive to the user wirelessly via the client device.

3. The system of claim 2, wherein the user location module is configured to receive geolocation information of the client device in real-time or near real-time, and wherein the incentive provision module is configured to transmit the incentive to the user based on the real-time or near real-time geolocation information of the client device.

4. The system of claim 1, wherein the redemption request module is configured to receive the redemption request from the client device.

5. The system of claim 1, wherein the redemption request module is configured to receive the redemption request from the merchant.

6. The system of claim 1, wherein the redemption request includes the identification of the incentive, and wherein the identification of the incentive uniquely identifies the incentive such that an identity of the user can be determined from the identification of the incentive.

7. The system of claim 1, wherein the user location module is configured such that the geolocation information includes Global Positioning System information obtained via wireless transmission from the client device.

8. A computer-implemented method of inhibiting fraud in redemption of incentives delivered to users via client devices, the method being implemented in a server having electronic storage and one or more processors configured to execute computer program modules, the method comprising:
receiving a redemption request for an incentive, wherein the incentive is defined by incentive criteria including an identification, an award, and a location requirement, wherein the redemption request indicates a request for the award by the user, and wherein the redemption request includes a redemption request time at which the user requested redemption of the incentive;
obtaining geolocation information specifying the geolocation of a client device associated with the user at the redemption request time;
comparing the geolocation information of the client device at the redemption request time with the location requirement;
verifying or not verifying the redemption request based on the comparison between the geolocation information of the client device at the redemption request time and the location requirement; and
granting the redemption request responsive to verification of the redemption request.

9. The method of claim 8, further comprising transmitting the incentive to the user wirelessly via the client device.

10. The method of claim 9, further comprising receiving geolocation information of the client device in real-time or near real-time, and wherein transmitting the incentive to the user is performed based on the real-time or near real-time geolocation information of the client device.

11. The method of claim 8, wherein the redemption request is received from the client device.

12. The method of claim 8, wherein the redemption request is received from the merchant.

13. The method of claim 8, wherein the redemption request includes the identification of the incentive, and wherein the identification of the incentive uniquely identifies the incentive such that an identity of the user can be determined from the identification of the incentive.

14. The method of claim 8, wherein the geolocation information includes Global Positioning System information obtained via wireless transmission from the client device.

15. A system configured to demonstrate demand for incentives for purchasing goods or services, the system comprising:
one or more processors configured to execute computer program modules, the computer program modules comprising:
an incentive request module configured to receive incentive requests from client devices associated with users for incentives for purchasing goods or services, the incentives being incentives not currently not currently offered to users through the system, wherein the incentive requests include incentive request criteria, the incentive request criteria for a given incentive request including an offeror identification and a merchant location;
an incentive demand module configured to determine user demand for incentives for purchasing goods or services at individual merchant locations; and
a demand reporting module configured to generate reports conveying the user demand for incentives for purchasing goods or services at the individual merchant locations.

16. The system of claim 15, wherein the incentive demand module is configured such that responsive to receiving incentive requests having a first offeror identification and a first merchant location, the incentive demand module determines user demand for incentives for a first offeror corresponding to the first offeror identification at the first merchant location.

17. The system of claim 16, wherein the demand reporting module is configured such that responsive to determination of the user demand for incentives for the first offeror at the first merchant location, the demand reporting module generates a report indicating the user demand for incentives for the first offeror at the first merchant location.

18. The system of claim 17, wherein the demand reporting module is further configured to transmit the report to the first offeror and/or to users that transmit incentive requests having the first offeror identification and the first merchant location.

19. The system of claim 15, wherein the incentive request module is configured to receive incentive requests that have been transmitted wirelessly from the client devices.

20. The system of claim 15, wherein the incentive request module is configured such that the merchant locations of the incentive requests are information indicating the locations of the client devices at the times the incentive requests were transmitted to the incentive request module.
